(19) United States
(12) Patent Application Publication
(10) Pub. No.: US 2006/0283935 A1
(43) Pub. Date: Dec. 21, 2006

(54) Systems and methods for processing commercial transactions

(76) Inventors: Scott Peter Henry, Temple, TX (US); Robert Harold Johnson, Highlands Ranch, CO (US)

Correspondence Address: PATRICK STELLITANO, 2803 INRDIGE DR, AUSTIN, TX, 78745, US

(21) Appl. No.: 11/435,395

(22) Filed: May 16, 2006

Related U.S. Application Data
(60) Provisional application No. 60/681,552, filed on May 16, 2005.

(51) Int. Cl. G06K 5/00; G06K 15/00; G06Q 20/00; G06Q 30/00

(52) U.S. Cl. 235/380; 235/383; 705/17; 705/15

(57) ABSTRACT

Embodiments include systems and methods for processing commercial transactions. Embodiments comprise a wireless terminal that wirelessly receives patron order data, displays the data, accepts commercial card payment and prints an itemized bill. Embodiments also upload commercial card information and download an authorization result.

### PRIORITY

This application claims priority of U.S. Provisional Application No. 60/681,552, filed May 16, 2005, which is incorporated herein by reference.

### FIELD

Embodiments are in the field of wireless communications. More particularly, embodiments are in the field of wireless processing of commercial transactions, especially in restaurants.

### BRIEF DESCRIPTION OF THE DRAWINGS

Aspects of the invention will become apparent upon reading the following detailed description and upon reference to the accompanying drawings in which like references may indicate similar elements:

FIG. 1 depicts an embodiment of an example wireless system for processing restaurant service transactions.

FIG. 2 depicts an embodiment of an example flowchart for wirelessly processing commercial transactions.

### DETAILED DESCRIPTION OF EMBODIMENTS

The following is a detailed description of embodiments of the invention depicted in the accompanying drawings. The embodiments are introduced in such detail as to clearly communicate the invention. However, the embodiment(s) presented herein are merely illustrative, and are not intended to limit the anticipated variations of such embodiments; on the contrary, the intention is to cover all modifications, equivalents, and alternatives falling within the spirit and scope of the appended claims. The detailed descriptions below are designed to make such embodiments obvious to those of ordinary skill in the art.

Embodiments include systems and methods for processing commercial transactions. Embodiments comprise a wireless terminal that wirelessly receives patron order data, displays the data, accepts commercial card payment and prints an itemized bill. Embodiments also wirelessly upload commercial card information and wirelessly download an authorization result.

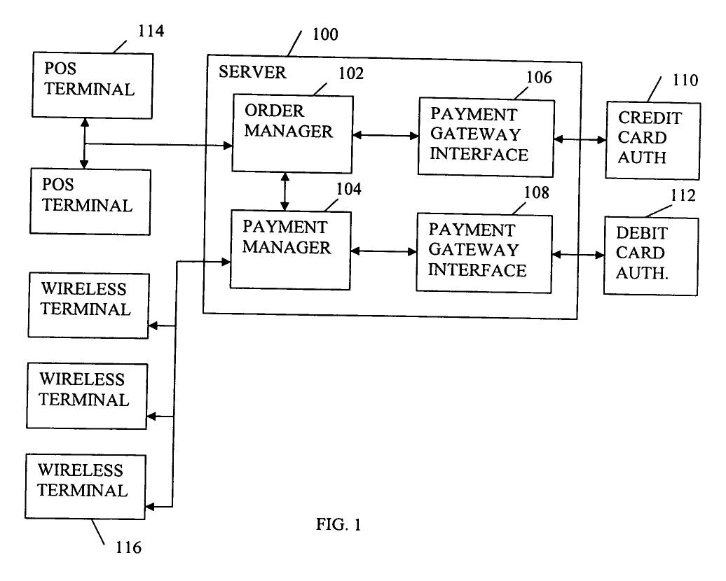

FIG. 1 shows an embodiment of an example wireless system for processing restaurant service transactions. The system comprises one or more point of sale (POS) terminals 114 and one or more wireless terminals 116 served by a server 100. A POS terminal 114 comprises a video monitor and a keyboard and allows a waiter or waitress (hereafter, “waiter”) to enter patron order data. Patron order data may comprise items on a restaurant's menu ordered by one or more patrons at a table, as well as the price of each ordered item. Thus, a POS terminal 114 may be located at a central location, such as a waiter's station. A POS terminal may be connected to server system 100 by wireline or may be connected to server 100 wirelessly; that is, over a radio frequency (RF) channel.

Server 100 connects wirelessly to one or more portable wireless terminals 116. Accordingly, server 100 comprises a transceiver (transmitter/receiver) to transmit information to a wireless terminal 116 and to receive information from a wireless terminal 116. A wireless terminal 116 comprises an alpha-numeric keypad, video display, a printer, a processor to execute computer code, a memory to store computer code, and a transceiver for wireless communication with server 100. The keypad may comprise function keys such as keys labeled “YES”, “NO”, “ENTER”, “CANCEL”, as well as arrows to cause the display to scroll, etc. The portable wireless terminal may be battery powered with an optional Alternating Current (AC) power line to provide power to charge the battery. The wireless terminal may also comprise a data port to receive data such as computer code to be executed by the processor of the wireless terminal.

Wireless terminal 116 may be handed to a patron at a table or at a curbside or placed on the patron's table to enable the patron to view his or her order data, a subtotal of an amount owed, a tip amount, an amount tendered, and other data. The patron, using the keypad, may enter data such as a tip amount and may cause the wireless terminal 116 to print out an itemized bill. Wireless terminal 116 also comprises a card reader to read a debit card or credit card. Thus, a patron, to pay for his bill, may swipe his card through the card reader which reads the card data from a magnetically encoded strip on the card. In the case of a debit card which requires a Personal Identification Number (PIN), the patron is prompted on the video screen of terminal 116 to enter his PIN using the keypad.

In addition to a transceiver, server 100 comprises a computer with a processor to execute computer code and with memory to store computer code. In the embodiment of FIG. 1, order manager software 102 is executed to provide order management functionality. Payment manager software 104 is executed to provide payment manager functionality. One or more payment gateway interfaces are provided to communicate vital credit card or debit card data to a credit card authorization system 110 or debit card authorization system 112, respectively.

The system of FIG. 1 may be implemented as a Wireless Local Area Network (WLAN) compatible with different parts of the Institute for Electrical and Electronics Engineers (IEEE) standard 802.11, including 802.11a, 802.11b, and 802.11g, as well 802.11n. The wireless network of FIG. 1 may also comply with other wireless standards. Thus, for example, a Wireless Access Point may reside between the server and the wireless terminals, or may be incorporated within the server.

The order manager 102 causes a window to be displayed on the video monitor of a POS terminal 114 that enables a waiter to input a patron's order data including table number, check number, items ordered and price per item. This information is received by order manager 102 which may send the order to a display of a terminal in the kitchen of the restaurant where the order is prepared. Order manager program 104 enables a waiter to split a check to create separate checks for each of a plurality of patrons at a table. Order manager program 104 also sends order data to payment manager 104 to be transmitted to a wireless terminal 116. Order manager 104 may also receive payment data, including amount tendered, credit card information, debit card information, and gift certificate information from payment manager 104.

The payment manager 104 facilitates communication with wireless terminals 116. Thus, payment manager program 104 may send to a wireless terminal 116 by way of the server's transceiver, formatted patron order data including a list of items ordered, price per item, order subtotal, recommended tip amounts, etc. Payment manager 104 receives from a wireless terminal 116, formatted payment data including amount tendered, tip amount, credit card information, debit card information, etc. In one embodiment, payment manager 104 routes debit card information, including card number, PIN, expiration date, and amount to be debited to a payment gateway interface 108. Payment gateway interface 108 is an interface that formats and transmits card information to a debit card authorization system 112. Debit card authorization system 112 is an external system that may be accessed by phone or internet or other means. Card authorization system 112 will authorize or reject debit card payment and transmit the authorization result back to payment gateway interface 108, which formats and transfers this information to payment manager 104.

In another embodiment, payment manager 104 routes credit card information, including card number and amount to be charged, to order manager 102. Order manager 102 routes this information to a payment gateway interface 106 which formats and transmits this information to a credit card authorization system 110. Credit card authorization system 110 is an external system that may be accessed by phone or internet or other means. Card authorization system 110 will authorize or reject credit card payment and transmit the authorization result back to payment gateway interface 106. The result is then formatted and transferred to payment manager 104 by way of gateway interface 106 and order manager 102. In yet another embodiment, payment manager 104 connects directly to payment gateway interface 106 to interchange credit card information.

Thus, in a typical transaction, a waiter will come to a patron's table and take the patron's order. The waiter will go to a POS terminal 114, and enter the patron's order data. This data is received by order manager 102 of server 100. Order manager 102 will send the order data to the kitchen, and will further store the data for future retrieval by payment manager 104 in response to a request from a wireless terminal 116. When the patron is finished with his meal, the waiter comes to the patron's table with a portable wireless terminal 116. The waiter swipes an ID card through the card reader and inputs the patron's check number or table number. Wireless terminal 116 transmits this data to payment manager 104 which verifies the waiter's ID. Payment manager 104 also retrieves patron order data corresponding to the check number or table number, formats the data, and transmits it to the wireless terminal 116.

Wireless terminal 116 wirelessly receives the applicable patron order data retrieved by payment manager 104 and displays an itemized check on a video display of wireless terminal 116. The display may comprise an itemized and priced list of food and drink items ordered and served to the patron as well as a subtotal. This list may be printed out through selection from the keypad of the wireless terminal. Header and footer information may also be printed including such information as the name of the establishment, the time, the date, etc. The wireless terminal may further display, a recommended tip, a select field to enable the patron to select a recommended tip amount, and a tip entry field to enable the patron to enter a tip amount. Upon entry or selection of a tip amount, or upon choosing not to tip, the wireless terminal may further display a total. Also, the display may provide an entry field for an amount tendered in cash, check or gift certificate to be applied toward payment of the bill and a total amount due, after subtracting an amount tendered by the patron by way of the keypad of wireless terminal 116.

Once a total amount due is computed, after entry of a tip amount and applying credit for any cash, check or gift certificates, the patron may print out the itemized check that includes: an itemized and priced list of food items ordered and served, a tip amount, any credits applied and a total amount due. Thus, the patron is given the option to select a form of payment such as by cash or check, gift certificate, credit card or debit card. The patron makes this selection. If payment is by a commercial card such as a credit card or debit card, the patron swipes his card through the card reader. If payment is by debit card the patron is prompted to enter his PIN. If payment is by cash, the patron or waiter may enter the amount tendered, and wireless terminal 116 will compute and display the change due, if any.

If payment is by credit card, then the credit card number and amount due is wirelessly transferred to payment manager 104. Payment manager 104 then seeks credit card authorization by way of a payment gateway interface that connects to a merchant's credit card authorization process 110. If payment is by debit card, then the card number, the patron's PIN, and the amount due, is wirelessly transferred to payment manager 104. Payment manager 104 then seeks debit card authorization by way of a payment gateway interface that connects to a merchant's debit card authorization process 112. Once payment by credit card or debit card is authorized, a message is sent to be displayed on wireless terminal 116 to indicate to the patron that the transaction has been approved. The patron may print out an itemized receipt with a signature line for the patron to sign to finally authorize the transaction.

Thus, embodiments include a method for processing commercial transactions. The method comprises wirelessly downloading patron order data to a portable wireless terminal, the patron order data comprising a list of ordered items and a price for each item. The patron order data is displayed on a display of the wireless terminal. A card reader through which a commercial card is swiped, accepts, patron commercial card data as payment for items ordered. Embodiments may further comprise accepting by a keypad of the wireless terminal a tip amount and an amount tendered in cash or by check or by gift certificate. The method may further comprise wirelessly uploading from the wireless terminal the patron payment data and wirelessly downloading a commercial card authorization result to the wireless terminal.

Some embodiments therefore comprise a wireless commercial transaction system. The system comprises an order management process to receive patron order data comprising items ordered by a patron and to transmit patron order data to a payment management process. The system further comprises a payment management process to wirelessly transmit patron order data received from the order management process to a portable wireless terminal and to wirelessly receive payment information from the portable wireless terminal. The payment information may comprise an amount tendered in cash and/or gift certificates, or commercial card information. The system may further comprise an interface process between the payment management process and a commercial card authorization process to transmit commercial card information and to receive an authorization result. The payment management process may wirelessly download to the wireless terminal the authorization result.

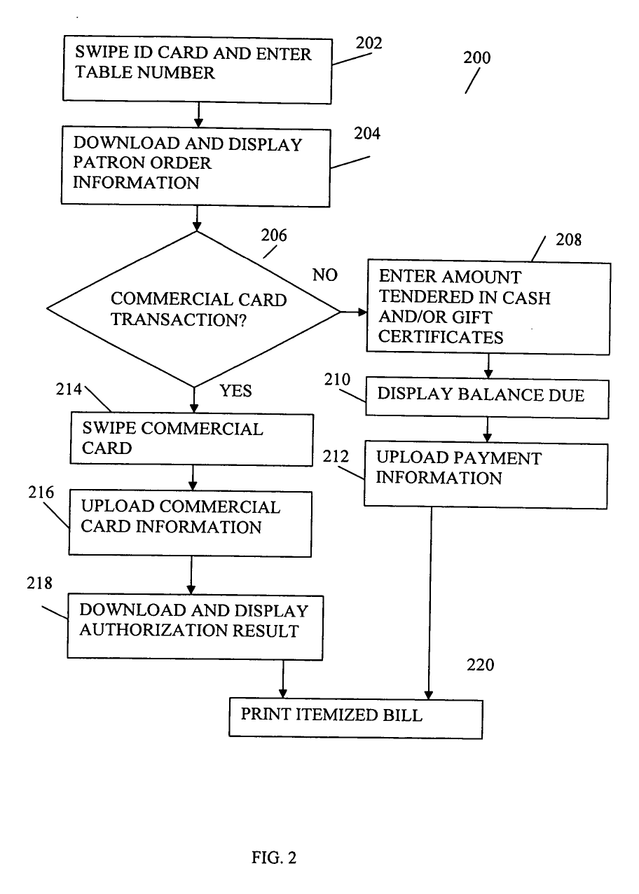

FIG. 2 shows an embodiment of an example flowchart 200 for processing commercial transactions. When a patron is ready to pay, the waiter brings to his table a portable wireless terminal. The waiter swipes his ID card through the card reader of the wireless terminal (element 202). Note that if the waiter's ID is not recognized or if the employee is not authorized to use the system, or if the employee is logged onto a different terminal, an error message may be returned and displayed on the wireless terminal. The waiter further enters a table number or check number (element 202) which identifies the patron order data to be downloaded. Note that if a check number is not found, or if the check is already closed, or if the check balance is zero, an error message may be returned and displayed on the wireless terminal. Note also, there may be multiple checks for a plurality of patrons at a single table. In this event the wireless terminal allows the waiter to choose in succession each one of the checks to be processed for payment.

If no error is returned, the wireless terminal then wirelessly downloads the patron order data (element 204). The patron order is displayed on the wireless terminal. An amount of a tip may also be entered by the patron or a tip amount may be selected by the patron. A menu is displayed to allow the user to select a form of payment. Thus, the wireless terminal accepts a patron entry by way of a keypad of the wireless terminal which indicates whether the payment is by commercial card such as a credit card or debit card (element 206). If payment is by cash, check, and/or gift certificate, the waiter or the patron enters the amount tendered (element 208). The wireless terminal then displays the balance due to the patron (element 210). The payment information is then uploaded wirelessly to the server (element 212).

If the patron chooses to pay by commercial card, the patron swipes his card through the card reader of the wireless terminal (element 214). The commercial card information, which in the case of a debit card includes a patron-entered PIN, is uploaded wirelessly to the server (element 216). The result of authorization of the commercial card is downloaded wirelessly to the wireless terminal and the authorization result is displayed (element 218). The wireless terminal prints out an itemized bill (element 220). In the case of payment by commercial card, a first copy may be printed to be kept by the patron, and a second copy may be printed with a signature line to be signed by the patron and given to the waiter. Thus, the printed check may include a header and footer including date and time, an itemized list of ordered items with a price for each one, a tip amount, an amount tendered in cash, check or gift certificate, a signature line, etc. Note that in an embodiment, if there is no activity at the wireless terminal for a specified period of time, the transaction may automatically be cancelled.

Some embodiments of the invention are implemented as a program product for use with an embedded processor. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-accessible format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Thus, another embodiment of the invention provides a machine-accessible medium containing instructions effective, when executing by a machine, to cause the machine to perform a series of operations for processing a commercial transaction. The operations comprise receiving wirelessly downloaded patron order data, the patron order data comprising a list of ordered items and a price for each item. The operations also comprise displaying patron order data on a display of the wireless terminal and accepting from a card reader, patron commercial card data for payment. The operations may further comprise displaying a recommended tip amount and accepting from a keypad a patron's tip amount. The operations may also comprise sending data to a printer to print an itemized bill. The operations may further comprise transmitting wirelessly through a transceiver, payment information, and receiving through the transceiver a commercial card authorization result.

The present invention and some of its advantages have been described in detail for some embodiments. Further description is provided in U.S. Provisional Application No. 60/681,552, filed May 16, 2005, which is incorporated herein by reference. It should be understood that although the process is described with reference to a restaurant service transaction, the process may be used in other contexts as well. It should also be understood that various changes, substitutions and alterations can be made herein without departing from the spirit and scope of the invention as defined by the appended claims. An embodiment of the invention may achieve multiple objectives, but not every embodiment falling within the scope of the attached claims will achieve every objective. Moreover, the scope of the present application is not intended to be limited to the particular embodiments of the process, machine, manufacture, composition of matter, means, methods and steps described in the specification. One of ordinary skill in the art will readily appreciate from the disclosure of the present invention that processes, machines, manufacture, compositions of matter, means, methods, or steps, presently existing or later to be developed are equivalent to, and fall within the scope of, what is claimed. Accordingly, the appended claims are intended to include within their scope such processes, machines, manufacture, compositions of matter, means, methods, or steps.

What is claimed is:

1. A method for processing commercial transactions, comprising:
wirelessly downloading patron order data to a portable wireless terminal, the patron order data comprising a list of ordered items and a price for each of one or more of the items;
displaying patron order data on a display of the wireless terminal; and
accepting by a card reader of the wireless terminal, patron commercial card data for payment if payment is to be made by commercial card.

2. The method of claim 1, further comprising accepting by a keypad of the wireless terminal a tip amount.

3. The method of claim 1, further comprising accepting by a keypad of the wireless terminal an amount tendered.

4. The method of claim 1, further comprising accepting by a keypad of the wireless terminal an amount of a gift certificate.

5. The method of claim 1, further comprising wirelessly uploading from the wireless terminal the patron commercial card data.

6. The method of claim 1, further comprising wirelessly downloading a commercial card authorization result to the wireless terminal.

7. A wireless commercial transaction system, comprising:
an order management process to receive patron order data comprising items ordered by a patron and to transmit patron order data to a payment management process; and
a payment management process to wirelessly transmit patron order data received from the order management process to a portable wireless terminal and to wirelessly receive payment information from the portable wireless terminal.

8. The system of claim 7, further comprising an interface process between the payment management process and a commercial card authorization process to transmit commercial card information and to receive an authorization result.

9. The system of claim 8, wherein the payment management process wirelessly downloads to the wireless terminal the authorization result.

10. The system of claim 7, wherein the payment management process wirelessly downloads to the wireless terminal an authorization result received from a commercial card authorization process.

11. The system of claim 7, wherein the payment information comprises commercial card information read by a card reader of the wireless terminal.

12. The system of claim 7, wherein the payment information comprises an amount tendered in cash.

13. The system of claim 7, wherein the payment information comprises an amount of a gift certificate.

14. A machine-accessible medium containing instructions for processing a commercial transaction, which, when the instructions are executed by a machine, cause said machine to perform operations, comprising:
receiving wirelessly downloaded patron order data, the patron order data comprising a list of ordered items and a price for each of one or more of the items;
displaying patron order data on a display of the wireless terminal; and
accepting from a card reader, patron commercial card data for payment if payment is to be made by commercial card.

15. The machine accessible medium of claim 14, wherein the operations further comprise displaying a recommended tip amount.

16. The machine accessible medium of claim 14, wherein the operations further comprise accepting from a keypad a patron's tip amount.

17. The machine accessible medium of claim 14, wherein the operations further comprise sending data to a printer to print an itemized bill.

18. The machine accessible medium of claim 14, wherein the operations further comprise receiving an authorization result.

19. The machine accessible medium of claim 18, further comprising displaying the authorization result.

20. The machine accessible medium of claim 14, wherein the operations further comprise sending to a transceiver payment data to be uploaded wirelessly to a server.
